(19) United States
(12) Patent Application Publication
(10) Pub. No.: US 2012/0164483 A1
(43) Pub. Date: Jun. 28, 2012

(54) METHOD FOR PRODUCING DECORATIVE METALLIC ARTICLE, AND DECORATIVE METALLIC ARTICLE

(75) Inventors: Masashi Hirama, Tokyo (JP); Rina Ebihara, Tokyo (JP); Tomoaki Kasukawa, Tokyo (JP); Akiyoshi Yatsugi, Tokyo (JP)

(73) Assignee: Aida Chemical Industries Co., Ltd, Tokyo (JP)

(21) Appl. No.: 13/375,438

(22) PCT Filed: Aug. 10, 2010
(86) PCT No.: PCT/JP2010/063532

§ 371 Date: Nov. 30, 2011

(30) Foreign Application Priority Data
Aug. 19, 2009 (JP) 2009-190373

(51) Int. Cl. B32B 15/01; B44C 1/28; B44C 1/22; C04B 35/64

(52) U.S. Cl. 428/673; 264/610; 156/63; 216/32

(57) ABSTRACT

Are disclosed a method for producing a decorative metallic article and the decorative metallic article, used in jewelry goods, ornaments, clothing accessories or the like, the decorative metallic article being produced by joining a silver alloy composition for firing which comprises silver or a silver alloy to another composition for firing which comprises copper or a copper alloy. The method for producing a decorative metallic article comprises the steps of: forming a shaped copper sinter by forming a shaped copper object using a plastic copper composition containing an organic binder and at least one kind of a powder metal selected from copper and a copper alloy, and subsequently by firing the shaped copper object to obtain a shaped copper sinter (3); and producing a shaped copper-silver sinter by forming a decorative object (6) after shaping the obtained shaped copper sinter (3) with a plastic silver composition containing an organic binder and at least one kind of a powder metal selected from silver or a silver alloy, and subsequently by firing the decorative object (6) to obtain a decorative object sinter (7).

### FIELD OF THE INVENTION

The present invention relates to a method for producing a decorative metallic article and the decorative metallic article, used in jewelry goods, ornaments, and clothing accessories or the like, the decorative metallic article being produced by joining a composition for firing comprising silver or a silver alloy to a composition for firing comprising copper or a copper alloy.

### BACKGROUND OF THE INVENTION

Conventionally, a brazing technique has been well known for joining (or adhesively joining) different kinds of metals having different colors and appearances. In the brazing technique, after rasping a joining surface of each metal to be joined, the joining surfaces are put together by applying flux, and various brazing filler metals such as a solder, a silver solder and a palladium solder are placed at the edge of the joined part. Then, after the water in the flux is vaporized by using a burner, the metal surfaces are joined by increasing a heating power of the burner. After the procedure, the product thus obtained is treated with pickling and polishing or the like, thereby to produce a joined product made of the different metals.

The brazing technique is used not only for joining the sinters each of which is produced by firing a plastic composition containing a metallic powder but for joined casting products. However, the brazing technique is a minute method needed to use specialized tools and agents, resulting in a longer time to master the skill of the technique.

As a method for using a plastic composition containing a precious metal powder, the patent documents 1 to 3 disclose methods for producing a metallic article which is made by joining different metal sinters. Herein, the patent documents 1 to 3 describe that copper is classified in the precious metals. However, copper has a markedly inferior anti-corrosion profile (or anti-oxidation profile) to the general precious metals such as gold, silver and platinum group metals. That is, copper and a copper alloy are oxidized when heated in the oxidative atmosphere (or in the air).

In the method described in the patent document 1, a plastic composition containing a first precious metal powder is formed in a plate shape, and then notch regions are formed by partially cutting the plate. Then, another plastic composition containing a second precious metal powder having a different color is filled to the notch regions, and the resultant product is fired.

In the patent document 2, the following method is proposed. That is, a plastic composition containing a first metal powder is shaped, and subsequently a plurality of through holes are formed therein. Then, another plastic composition containing a precious metal powder with a different color is filled in the through holes. The resultant product is cut out so that each plastic composition is exposed, and is fired. Alternatively, the resultant product is formed as a plate shape, and the plate shaped products are laminated, and rolled up to form a cylindrical shape. The cylindrical shaped product is cut out and fired.

In the method described in the patent document 3, the following steps are described. That is, a plurality of plastic precious metal compositions, each having a different color after firing, are preliminarily formed as a block shape or a plate shape. Then, the obtained products are joined together so that the pattern on the front side is different from the pattern on the rear side, whereby the resultant product is fired.

Here, the techniques described in the patent documents 1 to 3 are the method, in which a plurality of plastic compositions containing precious metal powders having different colors are prepared, and subsequently the obtained compositions are fired all at once in the state that the compositions are joined together. Therefore, when the joined area is small (or the joined portion is not broad), separation of the product after firing may be occurred. Accordingly, this method can be applied to a metallic article only designed to have a large joined area (or a broad joined portion), resulting in a large limitation of the design thereof.

Further, the patent documents 1 to 3 disclose no definite descriptions on the firing conditions. Particularly, the patent document 3 does not disclose any description on the atmosphere used in the firing.

In the meantime, the patent documents 1 and 2 describe the following procedures. That is, a plastic composition containing a pure gold powder is fired in the air such as the oxidation atmosphere, while a plastic composition containing a so called K18 alloy made by mixing gold, silver and copper in the rate of 75.0 wt %, 12.5 wt % and 12.5 wt % is fired in the argon atmosphere. In other words, it is disclosed that even though the plastic composition containing the K18 alloy only including copper in 12.5 wt %, the firing process thereof has to be conducted in the inert atmosphere.

As mentioned above, both patent documents 1 and 2 propose a method that plastic compositions containing metallic powders with different colors are fired in the physically joined state. However, there is no description on what firing conditions should be used, when a plastic composition A containing a pure gold powder to be fired in the oxidation atmosphere and a plastic composition B containing copper such as a K18 alloy to be fired in the inert atmosphere are joined together and fired.

Further, according to a reference document issued by the applicant of the patent documents 1 to 3, is described a method for firing a shaped object of a plastic composition containing powder of bronze which is a copper alloy including tin. That is, a bronze shaped object is placed on a bed of reduction agent such as a charcoal applied on an aluminum foil, and the bronze shaped object is covered by a stainless vessel and heated to 860° C. for 1 to 3 hr.

Meanwhile, the patent document 4 discloses a firing method composed of the first firing step and the next second firing step, to sinter a plastic composition containing a precious metal mixed powder containing silver and copper. The first firing step is conducted at 400° C. or more in the oxidation atmosphere, and the next second firing step is conducted at 800° C. or more in the reduction atmosphere.

However, the patent document 4 does not disclose each firing time of the first firing step and the next second firing step, which makes it impossible to conduct the verification test. In Examples of the patent document 4, only a few examples showing a K18 alloy composition as a gold alloy are described and no example is shown in which the larger amount of copper is contained than the content of the K18 alloy. Further, as platinum alloys, only two kinds of alloy compositions are tested, in which the smaller amounts of copper are contained than the contents in the above mentioned examples.

Therefore, although the patent document 4 describes that the first firing step is conducted in the oxidation atmosphere and the next second firing step is conducted in the reduction atmosphere, the technique disclosed in the patent document 4 is limited to the method for firing a plastic precious metal composition containing copper or a copper alloy. In this regard, the technique disclosed in the patent document 4 is not a firing technique for obtaining a metallic article which is formed in the combination of the plastic compositions containing different metals having different colors and appearances.

### PRIOR ART DOCUMENTS

### Patent Literatures

[Patent Document 1] Japanese Patent No. 2924139

[Patent Document 2] Japanese Patent No. 2932648

[Patent Document 3] Japanese Patent No. 3389613

[Patent Document 4] Japanese Patent No. 3191434

### DISCLOSURE OF THE INVENTION

### Problems to be Solved by the Invention

As described hereinbefore, it is well known that firing of a plastic copper composition containing copper or a copper alloy is basically conducted in the inert atmosphere, that is, in the reduction atmosphere. In contrast, assume a composite shaped object, formed by joining the plastic copper composition containing copper or a copper alloy to a plastic precious metal composition containing a precious metal such as silver having an anti-oxidation profile. If such a composite shaped object is fired, it is not known what conditions and procedures should be used specifically for producing a decorative metallic article without damaging the shaping by firing the composite shaped object. Note the anti-oxidation profile is a chemical property not being oxidized in the air when the composition is fired.

Further, in the conventional method, a plurality of plastic compositions containing different kinds of precious metal powders having different colors are prepared. Then, the plurality of plastic compositions are fired all at once in the state that the compositions are joined together. Accordingly, if the joined area is small, the product after firing may be separated. In order to avoid the separation of the product, it is needed to increase the joined area, resulting in the large limitation of the design thereof.

From the viewpoint of the disadvantages as mentioned above, the present inventors have been investigated to provide a method for producing a decorative metallic article and the decorative metallic article, used in jewelry goods, ornaments and clothing accessories or the like, the decorative metallic article being produced by joining a plastic copper composition containing copper or a copper alloy having a variety of colors including a brown color of copper, a bronze color and a nickel color of a copper and nickel alloy, to a plastic silver composition containing silver or a silver alloy. Accordingly, the present invention is finally realized.

Herein, a first object of the present invention is to provide a method for producing a decorative metallic article by firing a composite shaped object, formed by joining a plastic copper composition containing copper or a copper alloy to a plastic silver composition containing a precious metal of silver or a silver alloy, without damaging the shaping thereof.

Further, a second object of the present invention is to provide a method for producing a decorative metallic article and the decorative metallic article, which can be produced via a novel composite shaped sinter by joining a shaped copper sinter made of copper or a copper alloy to another sinter made of silver or a silver alloy, through a technique having no marked limitation in the designing such that the joined area has to be made broader.

### Means for Solving the Problems

According to the first aspect of the present invention, a method for producing a decorative metallic article includes the following steps. [Step of Producing Shaped Copper Sinter] includes steps of forming a shaped copper object by a plastic copper composition containing an organic binder and at least one kind of a powder metal selected from copper and a copper alloy, and subsequently firing the shaped copper object to obtain a shaped copper sinter. Then, [Step of Producing Shaped Copper-Silver Sinter] includes steps of forming a decorative object by shaping a plastic silver composition containing an organic binder and at least one kind of a powder metal selected from silver and a silver alloy, and subsequently firing the decorative object, thereby to obtain a decorative object sinter.

According to the method for producing a decorative metallic article, a shaped copper sinter is advancedly formed, then, a decorative object is formed by shaping the shaped copper sinter with a plastic silver composition, and finally the decorative object is fired. This allows the decorative metallic article to be obtained without damaging the shaping thereof.

Herein, when the order of the first stage firing and the second stage firing is reversed, a desired decorative metallic article may not be obtained without damaging the shaping thereof. That is, assume advancedly a shaped silver sinter is produced by firing a shaped silver object made of a plastic silver composition, and subsequently a decorative object is formed by shaping the shaped silver sinter with a plastic copper composition containing an organic binder and at least one kind of a powder metal selected from copper and a copper alloy. After conducting the above mentioned procedure, if the decorative object thus obtained is fired, the shaped silver sinter advancedly fired causes deformation by heat or causes melting thereof, which results in the marked deformation of the decorative article. This deformation is caused because the firing temperature of copper is higher than the firing temperature of silver. Accordingly, if the two stages of firing are conducted, a desired decorative metallic article is obtained without damaging the shaping thereof by the present invention, for the first time.

In the first stage firing, the shaped copper object may be fired in the reduction atmosphere or in the oxidation atmosphere. Further, in the second stage firing, the decorative object may be fired in the reduction atmosphere or in the oxidation atmosphere. Herein, when the first stage firing and the second stage firing are respectively conducted in the reduction atmosphere, as described in the patent document 4, the primary firing may be conducted in the oxidation atmosphere at the lower temperature of 300° C. to 500° C. for burning an organic binder contained in the plastic composition, and then the secondary firing may be conducted in the reduction atmosphere for firing a copper powder and a silver powder contained in the plastic composition.

Note the firing in the reduction atmosphere requires complicated procedure. For example, the inert gas such as argon gas or nitrogen gas has to be continuously flowed during the firing, and a reduction agent such as charcoal is put in a sealed vessel together with a shaped copper object, and the resultant mixture in the vessel is heated from the outside. Therefore, if it is possible to fire the plastic silver composition in the oxidation atmosphere in the second stage firing, it is preferable to also conduct the first stage firing in the oxidation atmosphere. In order to fire the shaped copper object in the oxidation atmosphere, it is required to make at least one kind of the powder metal selected from copper or a copper alloy in the plastic copper composition as fine as possible, which will be clear as shown in Examples described hereinafter.

Note the above mentioned terms “silver alloy” of the present invention mean an alloy of which silver content is 80 wt % or more including, for example, silver of grade 950, grade 925, grade 900 and grade 800 authorized by the Japan quality authorization system. The kind and the addition amount of the metals composing the silver alloy may be selected in the optional range as long as the silver alloy can be fired at the lower temperature than the firing temperature of the shaped copper object. The selection of kind and the addition amount of the above mentioned metals does not depend on the melting point of the silver alloy. That is, the firing temperature can be lowered by decreasing a particle diameter of the silver alloy powder, which allows the kind of the addition metal and the addition amount thereof to be suitably selected corresponding to the mean particle diameter of the alloy powder. For example, a silver-Pd alloy in which Pd is added in 1% may be shown.

On the other hand, the above mentioned terms “copper alloy” of the present invention mean an alloy of which copper content is 80 wt % or more including, for example, bronze, gunmetal and nickel.

Further, according to the present invention, the reduction atmosphere includes the inside atmospheric state of a sealed vessel in which a reduction agent such as charcoal (that is, a material easily oxidized by the shaped copper object when heated) is put together with the shaped copper object and heated from the outside of the vessel. Herein, according to the present invention, the reduction atmosphere is construed identical to the inert atmosphere such as the argon gas atmosphere.

According to the second aspect of the present invention, a method for producing a decorative metallic article comprises the following steps.

[Step of Producing Shaped Copper Sinter with Through Hole] includes steps of: forming a shaped copper object with a through hole by a plastic copper composition containing an organic binder and at least one kind of a powder metal selected from copper and a copper alloy, and subsequently firing the shaped copper object to obtain a shaped copper sinter.

Then, [Step of Forming Shaped Silver Object] includes steps of: separately forming an insertion part of a shaped silver object which is to be inserted into the through hole of the shaped copper sinter, an upper shaped silver object and a lower shaped silver object, or forming a shaped silver object by providing the insertion part of the shaped silver object at least with either of the upper shaped silver object or the lower shaped silver object.

Next, [Step of Setting Decorative Object] includes steps of: integrating the upper shaped silver object and the lower shaped silver object by using a paste of the plastic silver composition before or after drying the upper and lower shaped silver objects, thereby to forma decorative object in the state that the shaped copper sinter is held between the upper and lower shaped silver objects.

Finally, [Step of Firing Decorative Object] includes steps of: firing the decorative object treated in the above mentioned [Step of Setting Decorative Object], thereby to form a decorative object sinter in which the shaped copper sinter is held between the fired upper and lower shaped silver objects.

In the step of forming a shaped silver object and in the step of setting a decorative object, the insertion part of the shaped silver object may be formed alone, or formed by providing the insertion part of the shaped silver object at least with either of the upper shaped silver object or the lower shaped silver object. Alternatively, a plurality of insert parts of the silver objects may be separately formed as the insertion part of the shaped silver object. For example, the upper shaped silver object and the lower shaped silver object are formed by providing a short length insertion part of the shaped silver objects with both upper and lower shaped silver objects. Then, the short length insertion parts of the silver objects are integrated by using the paste of the plastic silver composition in the through hole of the shaped copper sinter, whereby a decorative object may be formed in the state that the shaped copper sinter is held between the upper and lower shaped silver objects.

Further, by using a syringe filled with the plastic silver composition, the plastic silver composition may be directly injected into the through hole of the shaped copper sinter from the syringe, to integrate the end part of the plastic silver composition near the peripheral outside of the through hole, the upper shaped silver object and the lower shaped silver object by using the paste of the plastic silver composition. Hereby, a decorative object may be formed in the state that the shaped copper sinter is held between the upper and lower shaped silver objects. Therefore, a variety of modified arrangements can be performed in the step of forming a shaped silver object and in the step of setting a decorative object, allowing the steps of the present invention to be taken in the broadest sense.

As mentioned hereinbefore, according to the second aspect of the present invention, in the method of producing the decorative metallic article, if the order of the first sage of firing the shaped copper object and the second stage of firing the decorative object produced by shaping the shaped copper sinter thus obtained with the plastic silver composition, is reversed, it is not possible to obtain a desired decorative metallic article without damaging the shaping thereof.

Further, even though the order of the first stage firing and the second stage firing is not changed, when the decorative object is fired in the state that the shaped silver object is held between the upper shaped copper sinter and the lower shaped copper sinter, instead of firing the decorative object in the state that the shaped copper sinter is held between the upper and lower shaped silver objects, it is not possible to produce a decorative object sinter in the state integrally fixed by tightly holding the central sinter between the sinters at both side.

This reason is explained as follows. That is, when the decorative object is fired in the state that the shaped copper sinter is held between the upper and lower shaped silver objects in the second stage firing, the insertion part of the shaped silver object shrinks in the ratio of about 10% by firing. This allows the decorative object sinter to be produced in the state integrally fixed by tightly holding the shaped copper sinter between the sinters of the upper and lower shaped silver objects in the step of firing a decorative object. However, when the decorative object is fired in the state that the shaped silver object is held between the upper shaped copper sinter and the lower shaped copper sinter, the insertion part of the copper sinter to be inserted into the through hole of the shaped silver object no more shrinks because the insertion part of the copper sinter has been already fired in the first stage firing. This prevents the decorative object sinter from being produced in the state integrally fixed by tightly holding the central sinter between the sinters at both sides.

According to the third aspect of the present invention, in the method for producing a decorative metallic article according to the second aspect, [Step of Setting Decorative Object] is conducted before drying the upper shaped silver object, the insertion part of the shaped silver object and the lower shaped silver object.

According to the method for producing a decorative metallic article in the third aspect, the upper shaped silver object, the insertion part of the shaped silver object and the lower shaped silver object made of the plastic silver composition, during drying or after drying (in the present invention, generally referred to as “after drying”), are easily inserted into the through hole of the shaped copper sinter and easily integrated together by using the paste of the plastic silver composition. This facilitates the operational efficiency to be improved and an elaborate decorative object to be formed. Further, these adjustments allow vacant spaces to be provided between the insertion part of the shaped silver object and the through hole of the shaped copper sinter, between the shaped copper sinter and the sinter of the upper shaped silver object, and between the shaped copper sinter and the sinter of the lower shaped silver object. Accordingly, this allows a rotatably fixed decorative object sinter to be obtained with being integrated and keeping the total strength thereof.

According to the fourth aspect of the present invention, in the method for producing a decorative metallic article according the third aspect, a paste of the plastic silver composition used in the [Step of Setting Decorative Object] is a paste-like plastic composition added separately, or a softened end part of the shaped silver object to be integrated; the end part being softened by moistening it with water.

According to the fourth aspect of the method for producing a decorative metallic article, when the end part of the shaped silver object is softened by moistening it with water, both end parts of the shaped silver object to be joined each other may be softened by moistening them with water, or only either of the end parts of the shaped silver object to be joined may be softened by moistening it with water.

According to the fifth aspect of the present invention, in the method for producing a decorative metallic article according to any one of the above mentioned first to fourth aspects, the shaped copper object is fired at the temperature from 850° C. to 990° C., and the decorative object is fired at the lower temperature than the firing temperature of the shaped copper sinter.

According to the fifth aspect of the method for producing a decorative metallic article, it is possible to surely prevent the shaped copper sinter advancedly formed in the first stage firing from being markedly deformed in the shape thereof by heat or causing the melting in the second stage firing of the plastic silver composition (that is, in the firing of the decorative object). This allows the decorative metallic article to be obtained by the firing without damaging the shaping thereof.

According to the fifth aspect of the method for producing a decorative metallic article, in the first stage firing, the shaped copper object may be fired in the reduction atmosphere or in the oxidation atmosphere. Further, in the second stage firing, the decorative object may be fired in the reduction atmosphere or in the oxidation atmosphere. Meanwhile, assume that the first stage firing and the second stage firing are respectively conducted in the reduction atmosphere. In such a case, as mentioned above, for example, the primary firing may be conducted in the oxidation atmosphere at the low temperature from 300° C. to 500° C. in order to burn the organic binder contained in the plastic composition, and then the secondary firing may be conducted in the reduction atmosphere for firing the copper powder and silver powder or the like.

According to the sixth aspect of the present invention, in the method for producing a decorative metallic article according to the above mentioned fifth aspect, the shaped copper object is fired in the oxidation atmosphere and the decorative object is also fired in the oxidation atmosphere.

According to the sixth aspect of the method for producing a decorative metallic article, when the plastic silver composition is fired in the second stage firing, although it is a rare case, the firing may be preferably conducted in the reduction atmosphere, for example, depending on the silver alloy components in the plastic silver composition. However, from the viewpoint of easier handling, the firing is generally conducted in the oxidation atmosphere. In this regard, it is consistent that the shaped copper object is fired in the oxidation atmosphere in the first stage firing, which allows the following complicated procedures to be avoided. That is, it is not necessary to continuously flow the inert gas such as argon gas and nitrogen gas, which is needed for the firing in the reduction atmosphere. Further, it is not necessary to put a reduction agent such as charcoal together with the shaped copper object in a sealed vessel and heat the mixture in the vessel from the outside. The above mentioned advantages allow the method for producing a decorative metallic article of the present invention to be more easily used in a further education school or the like.

In order to fire the shaped copper object in the oxidation atmosphere, it is required to make at least one kind of the powder metal selected from copper and a copper alloy in the plastic copper composition as fine as possible, which is clear as shown in Examples described hereinafter. This allows the respective melting point temperatures of the resultant fine copper powder or copper alloy powder to be lowered, even though the outside of each powder is oxidized when fired in the atmosphere. Accordingly, the inside (or inner part) of the powder is not influenced by the oxidation, thereby to promote the firing at the lower temperature, which allows the copper sinter to gain a specific level of the strength.

According to the seventh aspect of the present invention, in the method for producing a decorative metallic article according to the above mentioned sixth aspect, the powder metal selected from copper and a copper alloy in the plastic copper composition has a mean particle diameter of 10 μm or less.

According to the seventh aspect of the method for producing a decorative metallic article, the shaped copper object made of the plastic copper composition comprising the powder metal having a mean particle diameter of 10 μm or less; the powder metal being selected from copper and a copper alloy, may be fired without any problem, if the firing is conducted in the oxidation atmosphere.

Here, the terms “mean particle diameter” of the copper powder, the copper alloy powder, the silver powder and the silver alloy powder used in the present invention are also referred to as an average grain diameter, an average particle diameter, a median diameter, a median size, or a 50% particle size; are typically represented as “D50”; and means a particle size corresponding to 50% of a cumulative distribution curve. More specifically, the mean particle diameter is a value of D50 of a particle size distribution obtained by using a laser diffraction-type particle size distribution measurement device with tri-laser scattered light detection mechanism (manufactured by Microtrac, Inc.) and setting measurement conditions thereof at “particle permeability: reflection” and “spherical/nonspherical: nonspherical”.

According to the eighth aspect of the present invention, in the method for producing a decorative metallic article according to the above mentioned seventh aspect, the powder metal selected from copper and a copper alloy in the plastic copper composition is a mixed copper powder comprising a powder with a mean particle diameter of 2.5 μm in 50 wt % and another powder with a mean particle diameter of 10.0 μm in 50 wt %.

According to the eighth aspect of the method for producing a decorative metallic article, if the firing is conducted in the oxidation atmosphere, the shaped copper object made of the plastic copper composition may be fired without any problem, and the shrinkage ratio thereof may be lowered in about 10%. Further, it is possible to decrease the firing temperature of the plastic copper composition, and reduce the firing time.

According to the ninth aspect of the present invention, in the method for producing a decorative metallic article according to the above mentioned eighth aspect, the powder metal selected from silver and a silver alloy in the plastic silver composition is a mixed silver powder comprising a powder with a mean particle diameter from 2.2 to 3.0 μm in 30 to 70 wt % and the remainder powder with a mean particle diameter of 5 to 20 μm.

According to the ninth aspect of the method for producing a decorative metallic article, for example, if the firing is conducted in the oxidation atmosphere, the plastic silver composition may be fired without any problem and the shrinkage ratio may be kept in about 10% which is substantially the same as the shrinkage ratio shown when the plastic copper composition is fired in the eighth aspect. Further, it is possible to fire the plastic silver composition at the significantly lower temperature than the firing temperature of the plastic copper composition, and reduce the firing time. This allows the shaped copper sinter and the decorative object sinter to be produced without being damaged when the decorative object is fired.

According to the tenth aspect of the present invention, in the method for producing a decorative metallic article according to the above mentioned ninth aspect, [Step of Removing Surface Oxidation Film] is conducted for the decorative object sinter by performing pickling and polishing treatments.

According to the eleventh aspect of the present invention, in the method for producing a decorative metallic article, the shaped copper sinter made of copper or a copper alloy held between at least upper and lower two shaped silver sinters made of the material selected from silver and a silver alloy at a holding base part. Further, the outer end parts of each sinter are formed extending outwardly from the holding base part of the resultant product.

Therefore, according to the eleventh aspect, the method for producing a decorative metallic article of the present invention does not have the following the major limitation of the designing. That is, in the prior art, a plurality of plastic compositions containing precious metal powders having different colors are prepared, and subsequently the compositions are fired all at once in the state being joined together. In such a method, if the joined area is small, the fired product may be separated. Therefore, in order to avoid such separation of the product after firing, it should be required to forma lump-shaped object having a large joined area in the conventional designing. In contrast, by using the method of the present invention, it is possible to produce a decorative metallic article having an outstandingly three-dimensional and complicated shape compared to the conventional product.

Herein, the decorative metallic article of the present invention is generally a shaped decorative object sinter, in which the shaped silver sinters and the shaped copper sinter held therebetween are integrally fixed. Alternatively, it is also possible to produce the decorative object sinter in which the shaped copper sinter is rotatably fixed.

### ADVANTAGEOUS EFFECTS OF THE INVENTION

According to the method for producing the decorative metallic article of the present invention, the shaped copper sinter is advancedly prepared, subsequently the decorative object is formed by shaping the shaped copper sinter with the plastic silver composition, and finally the decorative object is fired. This allows the decorative metallic article to be obtained by firing without damaging the shaping thereof. Herein, if the order of the first stage firing of the shaped copper object made of the plastic copper composition and the second stage firing of the shaped silver object made of the plastic silver composition is revered, it is not possible to obtain the desired decorative metallic article without damaging the shaped silver sinter formed in the first stage firing.

Further, according to the method for producing the decorative metallic article of the present invention, the shaped copper sinter is provided with the through hole, and via the through hole of the shaped copper sinter, the upper shaped silver sinter and the lower shaped silver sinter are integrated so that the decorative object sinter is obtained, in which the shaped copper sinter is held between the shaped silver sinters. Accordingly, the method of the present invention does not have the following major limitation of the designing. That is, in the prior art, a plurality of plastic compositions containing precious metal powders having different colors are prepared, and subsequently the compositions are fired all at once in the state being joined together. In such a method, if the joined area is small, the fired product may be separated. Therefore, in order to avoid such separation of the product after firing, it should be required to form a lump-shaped object having a large joined area in the conventional designing. In contrast, by using the method of the present invention, it is possible to produce a novel composite shaped sinter by joining the shaped copper sinter made of copper or a copper alloy to the shaped silver sinter made of silver or a silver alloy.

Further, the decorative metallic article thus obtained is integrated by holding the shaped copper sinter between the upper and lower shaped silver sinters, and the outer end parts of each sinter are shaped extending outwardly form the holding base part. This allows the decorative metallic article to be formed in a flower-like shape excellent in decorativeness having the shape that the outer end parts radially extend from the holding base part as the central part. Accordingly, it is possible to form the outstandingly three-dimensional and complicated shape of the decorative metallic article compared to the conventional product.

### BRIEF DESCRIPTION OF THE DRAWINGS

FIG. 1 shows an exploded perspective view of the decorative object 6 formed by joining the upper shaped silver object having the insertion part of the shaped silver object, the shaped copper sinter and the lower shaped silver object in the example of the present invention.

FIG. 2 shows a plan view of the decorative object obtained by [Step of Setting Decorative Object] in the example of the present invention.

FIG. 3 shows a cross-sectional view of the decorative article cut by the III-III line in FIG. 2.

FIG. 4 is a perspective view of the decorative object sinter obtained in the example of the present invention.

### BEST MODE FOR CARRYING OUT THE INVENTION

Next, [Step of Producing Shaped Copper Sinter] and [Step of Producing Shaped Copper-Silver Sinter] in the first aspect of the present invention will be described, respectively.

### Step of Producing Shaped Copper Sinter

In this step, firstly a shaped copper object is formed by a plastic copper composition containing an organic binder and at least one kind of a powder metal selected from copper and a copper alloy, and subsequently the resultant shaped copper object is fired.

In this step, a through hole may be formed in the shaped copper object in the same method as in [Step of Producing Shaped Copper Sinter with Through Hole] in the second aspect of the present invention. Alternatively, a through hole may be formed in the shaped copper sinter obtained after firing by using an appropriate tool or the like.

Here, the plastic copper composition used in the above mentioned step comprises an organic binder and at least one kind of a powder metal selected from copper and a copper alloy.

As mentioned above, a variety of colors of copper and a copper alloy are known, including a brown color of copper, a bronze color and a nickel color of a copper and nickel alloy. Herein, a method for producing the copper powder or the copper alloy powder, including the atomization powder and the reduction powder thereof, is not limited specifically. However, a particle with a substantially spherical shape is preferably used. The mean particle diameter of the particle with 10 μm or less is more preferable because the shaped copper sinter made of the plastic copper composition can be fired without any problem in the oxidation atmosphere. Further, when a mixed copper powder comprising a powder with a mean particle diameter of 2.5 μm in 50 wt %, and another powder with a mean particle diameter of 10.0 μm in 50 wt % is used, it is possible to obtain a shaped copper sinter having a high bending strength. Further, it is possible to fire the plastic copper composition without any problem, and keep the shrinkage ratio in about 10%. Moreover, it is possible to lower the firing temperature of the plastic copper composition, and reduce the firing time. Therefore, it is preferable to use the aforementioned mixed powder to achieve the advantages as described above.

In the meantime, as described hereinafter, for example, when an additive such as a metal oxide including zirconium oxide is contained in the above mentioned mixed copper powder, even in such a case, it is also preferable that the mixed copper powder comprises a powder with a mean particle diameter of 2.5 μm and another powder with a mean particle diameter of 10.0 μm in the equivalent rate. For example, when the mixed copper powder comprises a metal oxide in the rate of 5.0 wt %, it is preferable that the mixed copper powder comprises the two kinds of powders in 47.5 wt %, respectively. By containing the respective copper powders in the equivalent rate, it is possible to achieve the same effect as mentioned hereinbefore. Herein, the particle size of the additive is not generally defined depending on the using purpose, when the metal oxide is used. It is preferable to use the particle with a mean particle diameter from 5 μm to 40 μm.

In short, the shaped copper object may be fired in the reduction atmosphere, in the inert atmosphere or in the oxidation atmosphere, in the above mentioned step. However, it is preferable to conduct the firing in the oxidation atmosphere, which can be performed in the air, if the procedure and costs needed are considered. That is, the firing conducted in the reduction atmosphere requires a complicated procedure, in which a reduction agent such as charcoal is put in a vessel together with the shaped copper object and the resultant mixture is heated from the outside of the vessel. The firing in the inert atmosphere requires higher costs because the inert gas such as the argon gas and the nitrogen gas has to be continuously flowed during the firing. Further, the shaped silver composition in the second stage firing may be fired in the reduction atmosphere, in the inert atmosphere or in the oxidation atmosphere. However, it is preferable to conduct the firing in the oxidation atmosphere, considering that the plastic silver composition can be fired in the simple oxidation atmosphere in the second stage firing.

Herein, in order to fire the shaped copper object in the oxidation atmosphere, it is required to make at least one kind of the powder metal selected from copper and a copper alloy in the plastic copper composition as fine as possible, which is clear as shown in Examples described hereinafter.

The organic binder usable in this invention is not limited specifically, however, may include at least one member selected from the following: a cellulose-based binder such as methylcellulose, ethylcellulose, hydroxyethylcellulose, hydroxypropylcellulose, hydroxypropylmethylcellulose, and carmellose (carboxymethylcellulose), sodium carboxymethyl cellulose, potassium carboxymethylcellulose, and calcium carboxymethylcellulose; an alginic acid-based binder such as sodium alginate; a polysaccharide-based binder such as starch, dogtooth violet starch, wheat flour, British gum, xanthane gum, dextrin, dextran, and pullulan; an animal-derived binder such as gelatin; a vinyl-based binder such as polyvinyl alcohol and polyvinylpyrrolidone; an acryl-based binder such as polyacrylic acid and polyacrylate ester; and other resin-based binder such as polyethylene oxide, polypropylene oxide, and polyethylene glycol, or the like. If the cellulose-based binder is used, a water-soluble cellulose-based binder is most preferably used.

### Step of Producing Shaped Copper-Silver Sinter

In this step, a decorative object is formed by shaping the shaped copper sinter thus obtained with a plastic silver composition containing an organic binder and at least one kind of a powder metal selected from silver and a silver alloy. Then, the decorative object is fired, thereby to obtain a decorative object sinter (or shaped copper-silver sinter).

The plastic silver composition used in the step comprises an organic binder and at least one kind of a powder metal selected from silver and a silver alloy. Herein, a method for producing the silver powder, including the atomization powder and the reduction powder thereof, is not limited specifically. However, a particle with a substantially spherical shape is preferably used. Further, a mixed silver powder comprising a powder with a mean particle diameter of 2.2 to 3.0 μm in 30 to 70 wt % and the remainder powder with a mean particle diameter of 5 to 20 μm is more preferably used. The combination of the plurality kinds of powders with the different mean particle diameters allows the firing to be conducted at the comparatively lower temperature. Further, a vacant space between the large particles is filled with the fine particles, allowing the sinter thus obtained to have a high density, whereby a silver sinter with a low shrinkage ratio can be obtained. Herein, it should be noted that the mean particle diameters and the contents of the fine particle and the large particle are specifically defined. Accordingly, it is found that the firing can be conducted at the low temperature of 160 to 210° C., lower than the melting point of the powder metal, and the shrinkage ratio by firing can be suppressed in less than 10% (or in the length).

In this step, when the decorative object is formed by shaping the shaped copper sinter with the plastic silver composition, any combination of the shaped copper sinter and the plastic silver composition may be applicable. As mentioned hereinbefore, when the through hole is formed in the shaped copper sinter, this formation of the through hole facilitates the attachment of the plastic silver composition. For example, as mentioned in the explanation of the second aspect described hereinafter, the plastic silver composition may be divided into two parts, and the upper part (one part) and the lower part (the other part) may be connected together in the through hole. Accordingly, by using the procedure, it is possible to obtain a decorative metallic article of the shaped copper-silver sinter, of which component parts are freely shaped respectively.

Further, the firing in this step may be conducted in the oxidation atmosphere at the lower temperature than the firing temperature of the shaped copper object.

Herein, it should be noted that if the order of the first stage firing (that is, the firing of the shaped copper object) and the second stage firing (that is, the firing of the shaped silver object) is reversed, the desired decorative metallic article can not be obtained. That is, assume the shaped silver object is advancedly fired to form the shaped silver sinter, and the decorative object is formed by shaping the shaped silver sinter with the plastic copper composition. After conducting the above mentioned procedure, if the decorative object thus obtained is fired, the decorative metallic article may be markedly deformed because the shaped silver object advancedly fired is deformed by heat or causes melting thereof. Herein, the deformation is caused because the firing temperature of copper is higher than the firing temperature of silver. Therefore, the desired decorative metallic article is obtained for the first time by the present invention, if the above mentioned two stages of firing are conducted.

Next, the following processes of [Step of Producing Shaped Copper Sinter with Through Hole], [Step of Forming Shaped Silver Object], [Step of Setting Decorative Object], and [Step of Firing Decorative Object] in the second aspect of the present invention will be explained, respectively.

### Step of Producing Shaped Copper Sinter with Through Hole

In this step, a shaped copper object with a through hole is formed by a plastic copper composition containing an organic binder and at least one kind of a powder metal selected from copper and a copper alloy, and subsequently the shaped copper object is fired.

The step is the same as [Step of Producing Shaped Copper Sinter] in the first aspect of the present invention, except that the through hole is formed in the shaped copper object. Herein, the firing may be conducted in the reduction atmosphere, in the inert atmosphere, or in the oxidation atmosphere.

Further, in this step, the through hole formed in the shaped copper object is a part where an insertion part of a shaped silver object is to be arranged in [Step of Setting Decorative Object] described hereinafter. Note the shape or size of the through hole is not limited specifically. Further, the plurality of through holes may be formed at a plurality of places, instead of forming one through hole at a single place.

### Step of Forming Shaped Silver Object

In this step, the insertion part of the shaped silver object which is to be inserted into the through hole of the shaped copper sinter, the upper shaped silver object, and the lower shaped silver object are separately formed by a plastic silver composition containing an organic binder and at least one kind of a power metal selected from silver and a silver alloy. Alternatively, at least either of the upper shaped silver object or the lower shaped silver object is formed to have the insertion part in the shaped silver object.

The plastic silver composition used in the step is the completely same as the plastic silver composition used in the first aspect of the present invention.

In the step, the upper shaped silver object and the lower shaped silver object are produced separately, and the shapes of the objects are not limited specifically. Herein, the insertion part of the shaped silver object to be inserted in the through hole of the shaped copper sinter may be formed as a different object from the upper shaped silver object and the lower shaped silver object. Alternatively, the insertion part of the shaped silver object may be formed as a protrusion part of either of the upper shaped silver object or the lower shaped silver object, or may be formed as protrusion parts of both upper and lower shaped silver objects. For example, when the insertion part of the shaped silver object is formed on each of the upper shaped silver object and the lower shaped silver object, each of the insertion parts may be bonded together in the state of confronting each other as in [Step of Setting Decorative Object] described hereinafter.

In short, the insertion part of the shaped silver object to be inserted in the through hole of the shaped copper sinter may be formed alone, or may be formed as a protrusion part of either of the upper shaped silver object or the lower shaped silver object. Alternatively, a plurality of insertion parts of shaped silver objects may be formed by dividing the original insertion part of the shaped silver object. For example, both upper shaped silver object and lower shaped silver object may be formed to have short length insertion parts of shaped silver objects. Then, the short length insertion parts of shaped silver objects may be integrated each other in the through hole of the shaped copper sinter by the paste of the plastic silver composition. Finally, a decorative object may be formed in the state that the shaped copper sinter is held between the upper shaped silver object and the lower shaped silver object.

Here, if the upper shaped silver object, the insertion part of the shaped silver object and the lower shaped silver object are dried after [Step of Producing Shaped Silver object], this procedure facilitates the above mentioned objects to be inserted into the through hole of the shaped copper sinter. Further, this procedure facilitates the operation of integrating the shaped silver objects by the paste of the plastic silver composition. These advantages allow the operational performance to be improved and the elaborate decorative object to be formed.

### Step of Setting Decorative Object

In this step, the upper shaped silver object, the insertion part of the shaped silver object and the lower shaped silver object are integrated by the paste of the plastic silver composition via the through hole of the shaped copper sinter, before or after drying the shaped silver objects. Hereby, a decorative object is formed in the state that the shaped copper sinter is held between the shaped silver objects.

The paste of the plastic silver composition used in the step is a paste-like plastic composition added separately, or a softened end part of the shaped silver object to be integrated; the end part being softened by moistening it with water.

For example, by using a syringe filled with the paste of the plastic silver composition (in the above explanation, referred to as “a paste-like plastic composition added separately”), the plastic silver composition may be directly injected into the through hole of the shaped copper sinter from the syringe, to integrate the end part of the insertion part of the shaped silver object near the peripheral outside portion of the through hole, the upper shaped silver object and the lower shaped silver object. Hereby, a decorative object may be formed in the state that the shaped copper sinter is held between the upper and lower shaped silver objects.

Further, when the end part of the shaped silver object is softened by moistening it with water, a very small amount of water is supplied to the end part by a paint brush or the like, and left it for some time. Then, after confirming that the end part of the silver object is softened, the end part of the silver object may be pressed to other silver objects to be integrated, thereby to adhere together.

### Step of Firing Decorative Object

In this step, the decorative object thus obtained in the above mentioned [Step of Setting Decorative Object] is fired, whereby a decorative object sinter is obtained, in which the shaped copper sinter is held between the upper shaped silver object and the lower shaped silver object.

Herein, the insertion part of the shaped silver object is shrunk in about 10% by firing. Therefore, it is possible to produce a decorative object sinter in the state that the shaped copper sinter is tightly held between the upper shaped silver object and the lower shaped silver object, to be integrally fixed, in the [Step of Firing Decorative Object].

In the meantime, considering the shrinkage of the insertion part of the shaped silver object by firing, the length of the insertion part of the shaped silver object is made a little bit longer and the diameter thereof is made smaller than the through hole of the shaped copper sinter. This allows vacant spaces to be arranged between the insertion part of the shaped silver object and the through hole of the shaped copper sinter, between the shaped copper object sinter and the upper shaped silver object, and between the shaped copper object sinter and the lower shaped silver object, in the [Step of Firing Decorative Object]. Accordingly, it is possible to obtain the rotatably fixed decorative object sinter, with keeping the total strength of the decorative object sinter as an integrated form.

Note that the diameter of the through hole in the shaped copper sinter is not specified because the diameter thereof is varied corresponding to the physical property of the plastic silver composition used in the step. However, the diameter is generally 1 mm or more, preferably 1.5 mm or more, and more preferably 2 mm or more.

The firing in this step may be conducted in the oxidation atmosphere at the lower firing temperature than the firing temperature of the shaped copper object, as in the [Step of Producing Shaped Copper-Silver Sinter] in the first aspect of the present invention.

Herein, as explained in the first aspect of the present invention, if the order of the first stage firing (that is, the firing of the shaped copper object) and the second stage firing (that is, the firing of the shaped silver object) is reversed, the desired decorative metallic article is not obtained.

### Step of Removing Surface Oxidation Film

In this step, the decorative object sinter is treated with pickling and polishing to remove an oxidation film formed on the surface thereof.

The pickling and polishing treatments are well known techniques used in the firing of the similar type of a plastic precious metal composition. In the pickling treatment, the decorative object sinter is dipped in a solution of a granular acid (commercially available product) or dilute sulfuric acid for about 5 min, polished by a brush or the like where necessary, and washed with water immediately. In the polishing treatment, since a variety of polishing tools such as a polishing spatula, a thread buff, Leutor, a sponge polishing material, and a stainless-steel brush are commercially available, these tools are appropriately selected and used for polishing.

Here, oxidation films are formed on the surface of the shaped copper sinter and the surface of the shaped silver sinter, respectively, when the decorative object sinter is produced by firing the decorative object in the oxidation atmosphere in the above mentioned [Step of Producing Shaped Copper Sinter with Through Hole] and [Step of Firing Decorative Object]. Therefore, the above mentioned oxidation films are removed in this step.

As mentioned above, when the mean particle diameter of the powder metal selected from copper and a copper alloy in the plastic copper composition is 10 μm or less, even if the oxidation film is formed on the surface of the shaped copper sinter when fired in the oxidation atmosphere, the oxidation film is easily removed by the pickling and polishing treatments.

Further, the following additive may be added to the organic binder where necessary.

The additive includes one or more members selected from the following: organic acid (oleic acid, stearic acid, phthalic acid, palmitic acid, sebacic acid, acetylcitric acid, hydroxybenzoic acid, lauric acid, myristic acid, caproic acid, enanthic acid, butyric acid, capric acid, citric acid); organic acid ester such as n-dioctyl phthalate and n-dibutyl phthalate (organic acid ester having a methyl group, ethyl group, propyl group, butyl group, octyl group, hexyl group, dimethyl group, diethyl group, isopropyl group, and isobutyl group); higher alcohol (octanol, nonanol, decanol); polyol (glycerin, arabite, sorbitan, diglycerin, isoprene glycol, 1,3-butylene glycol); ether (dioctyl ether, didecyl ether); lignin which may be cited as a concrete example of the reticular macromolecular substance that results from the condensation of the component unit having phenylpropane as a backbone; liquid paraffin; and oil, or the mixture thereof (for example, olive oil containing rich oleic acid), etc. The additive is added so as to improve plasticity or prevent the plastic copper composition or the plastic silver composition from sticking to a hand during shaping. The lignin and glycerin above-cited as the additive give an appropriate level of a water retention property.

The additive also includes an anionic, cationic, nonionic, or any other surfactant. The surfactant improves miscibility between the precious metal powder and the organic binder, and improves the water retention property.

Of the organic binders, the water-soluble cellulose-based binder gives plasticity to the plastic copper composition and the plastic silver composition. The polyethylene oxide gives a high viscosity at a low concentration and increases adhesiveness in its liquid form. The sodium alginate gives an appropriate level of a water retention property, similarly to glycerin and also helps increase adhesiveness. The polyacrylate ester and polyacrylic acid further increase adhesiveness.

As mentioned above, the water-soluble cellulose-based binder gives plasticity to the plastic copper composition and the plastic silver composition. The water-soluble cellulose-based binder includes: methylcellulose, hydroxyethylcellulose, hydroxypropylcellulose, hydroxypropylmethylcellulose, sodium carboxymethylcellulose, potassium carboxymethylcellulose, calcium carboxymethylcellulose, etc, and is used by being dissolved in water.

If the aforementioned water-soluble cellulose-based binder is used as the organic binder, the amount of the organic binder in the plastic copper composition or the plastic silver composition is preferably in the range of 0.1 to 4 wt % by the dry solids content excluding water as the solvent. In this case, if the amount of the organic binder is less than 0.1 wt %, it is difficult to obtain a homogeneous plastic copper composition or a homogeneous plastic silver composition. Further, the strength after application or drying becomes disadvantageously lowered. If the amount of the organic binder is more than 4 wt %, the shrinkage ratio of the obtained object is increased and the object tends to easily crack. Accordingly, the amount of the organic binder is preferably in the range of 0.1 to 4 wt %.

If polyethylene oxide is used, the polyethylene oxide preferably has a molecular weight from a hundred thousand to several millions and is used in the amount in the range of 0.1 to 3 wt %.

Further, if a surfactant is used, the amount thereof is preferably in the range of 0.03 to 3 wt %. If oil is used, the amount thereof is preferably in the range of 0.1 to 3 wt %.

Further, an appropriate amount of water is added to the above mentioned plastic composition. If the amount of added water is too small, the plastic composition becomes hard resulting in difficult to be shaped, while if the amount of added water is too much, it is difficult to keep the shape of the product after shaping. Herein, the plastic copper composition and the plastic silver composition used in the present invention can be prepared as a clay-like form or a paste-like form, by adjusting the content of water.

In the preferable composition, a metallic powder is contained in 75 to 99 wt % in both plastic compositions. If the content of the metallic powder is too small, the shrinkage ratio is increased to obstruct the firing, while if the content thereof is too much, hereby the contents of the organic binder and water are decreased to obstruct the shaping.

As a firing accelerator, a powder of Bi, Se, Sb, In, Sn, Zn and Pd or an alloy powder thereof may be added to the plastic composition.

Further, as an adhesiveness improver, a glass powder or a metallic compound powder selected from lead carbonate, lithium carbonate, zinc oxide, phosphoric acid, sodium carbonate, vanadium oxide, sodium silicate, phosphate salt, or the like may be added to the plastic composition.

Further, an organic additive may be added so as to improve the plasticity of the plastic composition. The organic additive includes lignin which may be cited as a concrete example of the reticular macromolecular substance that results from the condensation of the component unit having phenylpropane as a backbone, glycerin, diglycerin, isoprene glycol, 1,3-butylene glycol, liquid paraffin, alcohols, oil, phthalic acid, n-dioctyl phthalate, n-dibutyl phthalate, and polyvinyl alcohol. Further, a surfactant and a surface-active agent may be also added where necessary.

Moreover, a metal oxide such as zirconium oxide may be added so as to prevent the deformation of the resultant product in the firing. That is, the addition of a metal oxide allows the firing rate to be delayed, which results in facilitating a gas diffusion passage to be formed, through which gas generated when the organic binder burns diffuses to the outside of the plastic composition.

### EXAMPLES

### Example 1

### Effect of Mean Particle Diameter of Copper Powder in Copper Sinter

<Materials Used>

In Experiment A, a copper powder composing a plastic copper composition was prepared as a mixed copper powder, by mixing a copper powder with a mean particle diameter of 2.5 μm in 50 wt % and another copper powder with a mean particle diameter of 10 μm in 50 wt %. Then, the mixed copper powder in 90 wt %, methylcellulose in 1.20 wt % and sodium carboxymethylcellulose in 0.30 wt % as organic binders, and water in 8.50 wt % were sufficiently mixed to form a clay-like composition. By using the clay-like composition, a sample piece was prepared having a length of 50 mm, a width of 10 mm, and a thickness of 1.5 mm, and dried at 80° C. for 30 min. The shrinkage ratio of the sample piece was determined by measuring the lengths thereof before and after drying. Then, the sample piece was fired in the air (or oxidation atmosphere) by using an electric furnace at 970° C. for 30 min to obtain a copper sinter. The surface of the cupper sinter thus obtained was polished to produce a test piece.

The bending strength of the test piece was analyzed based on a three-point bending test. More specifically, the central part of the test piece was pressed and bent to a depth of 10 mm by an indenter with a speed of 50 mm/min. At that time, a load value was measured and the bending strength was calculated by the following equation.

Bending Strength=3PI/2bd²
P: Load Value
I: Distance between Fulcrums
b: Width of Test Piece
d: Thickness of Test Piece

In Experiment B to Experiment E, each mixed copper powder having the powder composition shown in Table 1 was prepared, and each sample piece was formed in the same method as in Experiment A. Then, each sample piece was fired under the same conditions as in Experiment A. The surface of the obtained copper sinter was treated by pickling and polishing to produce each test piece. Note the mixed copper powder comprising two kinds of powders shown in Table 1 was prepared in the equal combination rate (that is, each in 50 wt %). Similarly, the mixed copper powder comprising three kinds of powders shown in Table 1 was also prepared in the equal combination rate (that is, each in 100/3 wt %).

<Results>

TABLE 1

| | | | | | Bending | |
|---|---|---|---|---|---|---|
| | Cu Powder (Mean | | | | Strength | Shrinkage |
| | Particle Diameter) | | | | (kgf/ | Ratio |
| | 2.5 μm | 5 μm | 10 μm | 40 μm | mm²) | (%) |
| Experiment A | used | | used | | 16.75 | 9.53 |
| Experiment B | used | used | used | | 16.75 | 9.53 |
| Experiment C | used | used | | | 16.71 | 10.29 |
| Experiment D | | used | | used | 7.01 | 4.43 |
| Experiment E | used | used | | used | 14.12 | 8.75 |

<Discussion>

It was confirmed that the addition of the fine copper powder with a mean particle diameter of 2.5 μm accelerated the firing of the copper mixed powder, which resulted in the production of the copper sinter having about 2-fold higher strength than the copper sinter in Experiment D in which no fine copper powder was added.

Further, each plastic copper composition containing the mixed copper powder with a mean particle diameter of 10 μm or less in Experiment A to Experiment C had a beautiful surface by pickling and polishing treatments after firing, even if the firing was conducted in the oxidation atmosphere. Accordingly, it was confirmed that the conditions defined in the seventh aspect of the present invention were desirable.

Among the plastic silver compositions, particularly, the plastic silver composition in Experiment A containing the copper mixed powder including the copper powder with a mean particle diameter of 2.5 μm in 50 wt % and the copper powder with a mean particle diameter of 10 μm in 50 wt % showed the most desirable result. Accordingly, it was confirmed that the conditions defined in the eighth aspect of the present invention were more desirable.

In contrast, each plastic copper composition in Experiment D and Experiment E, in which the copper powder with a mean particle diameter of 40 μm was added, had a weak bending strength, resulting in the production of the undesirable shaped copper sinter. However, when the above mentioned plastic copper composition was fired in the argon atmosphere, a shaped copper sinter which was sufficiently used as a decorative article was obtained.

### Example 2

### Production of Decorative Metallic Article having Complicated Flower Shaped Design

1. Step of Producing Shaped Copper Sinter with Through Hole

Similarly to the method in Example 1, a mixed copper powder including a copper powder with a mean particle diameter of 2.5 μm in 50 wt % and another copper powder with a mean particle diameter of 10 μm in 50 wt % was used. Then, the mixed copper powder in 90 wt %, methylcellulose in 1.20 wt % and sodium carboxymethylcellulose in 0.30 wt % as organic binders, and water in 8.50 wt % were sufficiently mixed to form a clay-like plastic copper composition.

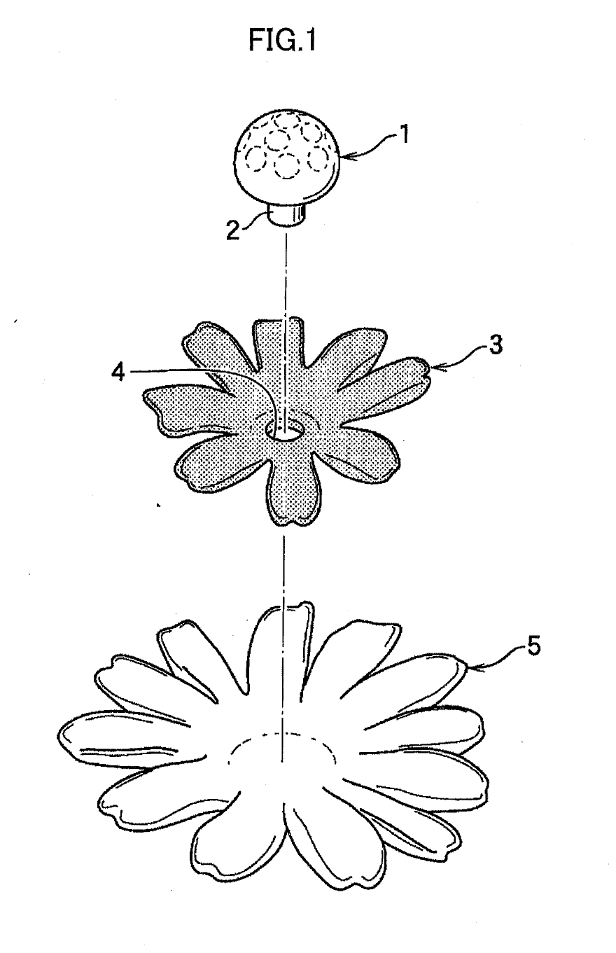

Then, the plastic copper composition was shaped using a hand, a jig such as a spatula, or a mold where necessary, thereby to form a shaped copper object having a circular shaped through hole 4 in the center of the object as shown in the middle part of FIG. 1. Herein, the shaped copper object had a shape that a plurality of flower petals radially extended outwardly from the through hole 4.

Next, the shaped copper object thus formed was dried at 80° C. for 30 min, and subsequently fired at 970° C. for 30 min in the air (or oxidation atmosphere) by using an electric furnace, thereby to obtain a shaped copper sinter 3.

### 2. Step of Forming Shaped Silver Sinter

A mixed silver powder in 92 wt % including a silver powder with a mean particle diameter of 2.5 μm in 46 wt % and another silver powder with a mean particle diameter of 20 μm in 46 wt %, and a water-soluble binder including starch in 0.7 wt %, cellulose in 0.8 wt % and the remainder of water, were sufficiently mixed, thereby to form a clay-like plastic silver composition.

Then, the plastic silver composition was shaped using a hand, a jig such as a spatula, or a mold where necessary, thereby to form an upper shaped silver object 1 shown at the upper part in FIG. 1 and a lower shaped silver object 5 shown at the bottom part in FIG. 1.

Herein, the upper shaped silver object 1 was formed in a pollen assembly shape having a protrusion part (or insertion part of the shaped silver object 2) extending from the rear side of the object 1 to downward as shown in FIG. 1. Further, the lower shaped silver object 5 was formed in a shape that a plurality of flower petals radially extended to outward from the substantial center of the object 5 as shown in the bottom part of FIG. 1.

Then, after shaping, the upper shaped silver object 1 having the insertion part of the shaped silver object 2 and the lower shaped silver object 5 were dried at 80° C. for 30 min.

### 3. Step of Setting Decorative Object

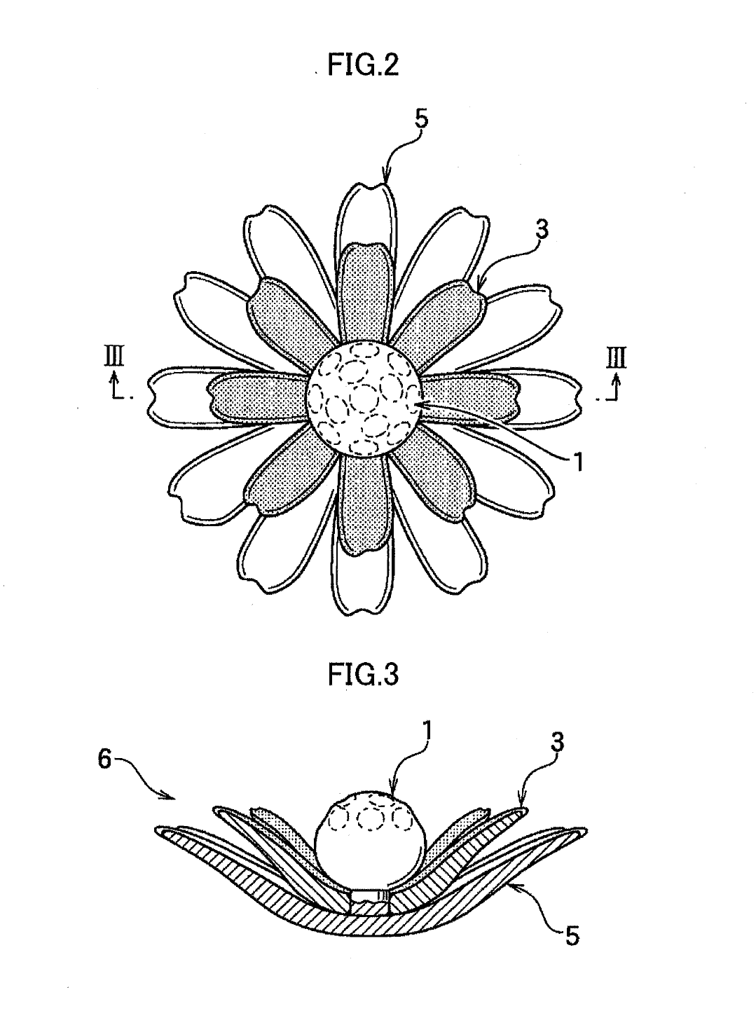

As shown in FIG. 1, the shaped copper sinter 3 obtained in the aforementioned step 1 was arranged on the lower shaped silver object 5 obtained in the aforementioned step 2. Then, the protrusion part 2 (or insertion part of the shaped silver object 2) of the upper shaped silver object 1 obtained in the aforementioned step 2 was fit into the through hole 4 to be arranged and attached. In this process, as shown in FIGS. 2 and 3, the arrangement was carefully conducted so that the respective petals of the lower shaped silver object 5 were not overlapped to the respective petals of the shaped copper sinter 3.

Herein, when the protrusion part 2 was fit into the through hole 4, the paste made by adding a small amount of water to the plastic silver composition used in the aforementioned step 2 was applied to the end part of the protrusion part 2 for being glued. Accordingly, a decorative object 6 was produced in the state that the shaped copper sinter 3 was held between the upper shaped silver object 1 and the lower shaped silver object 5.

### 4. Step of Firing Decorative Object

The decorative object 6 obtained in the step 3 was fired at 650° C. for 30 min in the air (or oxidation atmosphere) by using an electric furnace.

### 5. Step of Removing Surface Oxidation Film

The decorative object sinter (or decorative metallic article) 7 obtained in the step 4 was treated with pickling or polishing to remove an oxidation film formed on the surface of the decorative object sinter 7. In the pickling treatment, a commercially available granular acid was dissolved in warm water and used. In the polishing treatment, a polishing spatula or a thread buff was used.

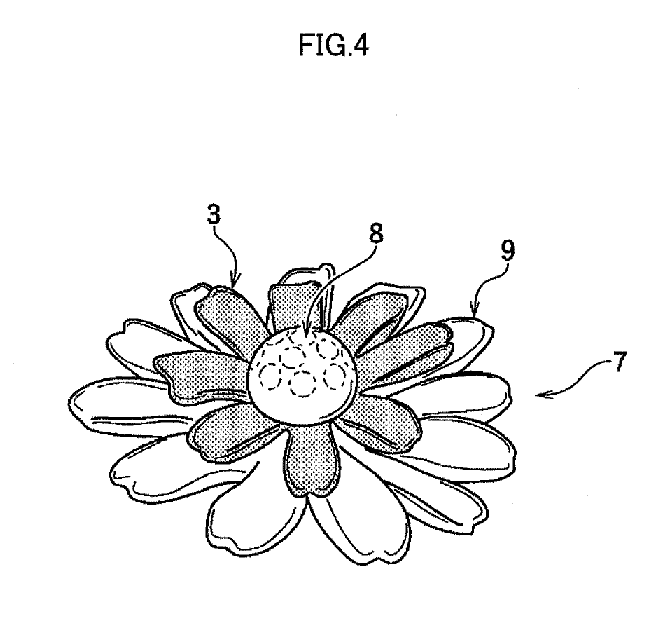

Finally, as shown in FIG. 4, the shaped copper sinter 3 was held up and down between the upper shaped silver sinter 8 and the lower shaped silver sinter 9, to complicatedly assemble these sinters. Accordingly, a decorative object sinter (or decorative metallic article) 7 having an extremely three-dimensional and complicated shape compared to the conventional product was obtained.

Further, in the production of the decorative object sinter (or decorative metallic article) 7, the Step of Setting Decorative Object was conducted after drying the upper shaped silver object 1 having the insertion part of the shaped silver object 2 and the lower shaped silver object 5. This facilitated the insertion of the above mentioned object to the through hole 4 of the shaped copper sinter 3, and also the integrally assembling work by the paste of the plastic silver composition.

Moreover, in the production of the article 7, the firing in the aforementioned step 1 and the firing in the Step of Firing Decorative Object were conducted in the oxidation atmosphere. This allowed the complicated procedures to be avoided and the firing in both steps to be easily conducted by using a general electric furnace. Particularly, in the firing in the Step of Firing Decorative Object, which was the second stage firing, no melting and deformation of the shaped copper sinter 3 were occurred. Further, in the aforementioned firing, although the oxidation film was formed on the surface of the sinter, the oxidation film was easily removed in a short time in the Step of Removing Surface Oxidation Film, allowing a beautiful metal surface to be obtained.

### Example 3

### Production of Decorative Metallic Article having Complicated Flower Design

A copper mixed powder in 90 wt % (mixed weight composition: a copper powder with a mean particle diameter of 2.5 μm in 47.5 wt % and another copper powder with a mean particle diameter of 10 μm in 47.5 wt %, as organic binders, methylcellulose in 1.20 wt %, hydroxypropylmethylcellulose in 0.15 wt %, starch 0.8 wt %, lignin 0.10 wt %, and water in 7.75 wt % were sufficiently mixed to form a clay-like plastic copper composition.

Except for using the above mentioned plastic copper composition, in the same method as in Example 2, the Step of Forming Shaped silver Sinter, the Step of Setting Decorative Object, the Step of Firing Decorative Object and the Step of Removing Surface Oxidation Film were conducted, whereby a decorative object sinter (or decorative metallic article) was obtained.

In this production of the decorative object sinter (or decorative metallic article), the Step of Setting Decorative Object was conducted after drying the upper shaped silver object 1 having the insertion part of the shaped silver object 2 and the lower shaped silver object 5. This facilitated the insertion of the above mentioned object to the through hole 4 of the shaped copper sinter 3, and also the integrally assembling work by the paste of the plastic silver composition.

Further, similarly to Example 2, in the production of the article, the firing in the Step of Producing Shaped Copper Sinter with Through Hole and the firing in the Step of Firing Decorative Object were conducted in the oxidation atmosphere. This allowed the complicated procedures to be avoided and the firing in both steps to be easily conducted by using a general electric furnace. Particularly, in the firing in the Step of Firing Decorative Object, which was the second stage firing, no melting and deformation of the shaped copper sinter 3 were occurred. Further, in the aforementioned firing, although the oxidation film was formed on the surface of the sinter, the oxidation film was easily removed in a short time in the Step of Removing Surface Oxidation Film, allowing a beautiful metal surface to be obtained.

### DESCRIPTION OF REFERENCE CHARACTERS

1 upper shaped silver object (having insertion part of shaped silver object)
2 insertion part of shaped silver object
3 shaped copper sinter
4 through hole
5 lower shaped silver object
6 decorative object
7 decorative object sinter (or decorative metallic article)
8 upper shaped silver object sinter
9 lower shaped silver object sinter

1. A method for producing a decorative metallic article, the method comprising the steps of:
producing a shaped copper sinter, by forming a shaped copper object by a plastic copper composition containing an organic binder and at least one kind of a powder metal selected from copper and a copper alloy, and subsequently by firing the shaped copper object to obtain a shaped copper sinter; and
producing a shaped copper-silver sinter, by forming a decorative object after shaping the obtained shaped copper sinter with a plastic silver composition containing an organic binder and at least one kind of a powder metal selected from silver and a silver alloy, and subsequently by firing the decorative object to obtain a decorative object sinter.

2. A method for producing a decorative metallic article, the method comprising the steps of:
producing a shaped copper sinter with a through hole, by forming a shaped copper object having a through hole by a plastic copper composition containing an organic binder and at least one kind of a powder metal selected from copper and a copper alloy, and subsequently by firing the shaped copper object to obtain a shaped copper sinter;
forming a shaped silver object, by separately forming an insertion part of a shaped silver object to be inserted into the through hole of the shaped copper sinter, an upper shaped silver object and a lower shaped silver object, or by forming at least either of the upper shaped silver object or the lower shaped silver object so as to have the insertion part of the shaped silver object, by using a plastic silver composition containing an organic binder and at least one kind of a powder metal selected from silver and a silver alloy;
setting a decorative object, by integrating the upper shaped silver object, the insertion part of the shaped silver object and the lower shaped silver object by using a paste of the plastic silver composition through the through hole of the shaped copper sinter, before or after drying the shaped silver objects, thereby to form a decorative object in a state that the shaped copper sinter is held between the upper shaped silver object and the lower shaped silver object; and
firing the decorative object, by firing the decorative object obtained in the step of setting a decorative object, thereby to obtain a decorative object sinter so that the shaped copper sinter is held between sinters of the upper shaped silver object and the lower shaped silver object.

3. The method for producing a decorative metallic article as described in claim 2,
the step of setting a decorative object being conducted after drying the upper shaped silver object, the insertion part of the shaped silver object and the lower shaped silver object.

4. The method for producing a decorative metallic article as described in claim 3,
the paste of the plastic silver composition used in the step of setting a decorative object being a paste-like plastic composition added separately, or a softened material prepared by moistening an end part of the shaped silver object to be integrated, with water so as to be softened.

5. The method for producing a decorative metallic article as described in any one of claims 1 to 4,
the shaped copper object being fired at 850° C. to 990° C., and the decorative object being fired at a lower temperature than the firing temperature of the shaped copper object.

6. The method for producing a decorative metallic article as described in claim 5,
the shaped copper object being fired in an oxidation atmosphere, and the decorative object being fired also in an oxidation atmosphere.

7. The method for producing a decorative metallic article as described in claim 6,
the powder metal selected from copper and a copper alloy in the plastic copper composition having a mean particle diameter of 10 μm or less.

8. The method for producing a decorative metallic article as described in claim 7,
the powder metal selected from copper and a copper alloy in the plastic copper composition being a mixed copper powder including a powder having a mean particle diameter of 2.5 μm in 50 wt % and a powder having a mean particle diameter of 10.0 μm in 50 wt %.

9. The method for producing a decorative metallic article as described in claim 8,
the powder metal selected from silver and a silver alloy in the plastic silver composition being a mixed silver powder consisting of a powder having a mean particle diameter of 2.2 to 3.0 μm in 30 to 70 wt % and the remainder powder having a mean particle diameter of 5 to 20 μm.

10. The method for producing a decorative metallic article as described in claim 9, further comprising a step of removing a surface oxidation film, by pickling or polishing the decorative object sinter.

11. A decorative metallic article in which a shaped copper sinter made of copper or a copper alloy comprises a through hole to be integrally held between at least upper and lower two shaped silver sinters made of members selected from silver and a silver alloy via the through hole at a holding base part, and outer end parts of each sinter are shaped extending outwardly from the holding base part.
